(19) United States
(12) Patent Application Publication
(10) Pub. No.: US 2026/0160599 A1
(43) Pub. Date: Jun. 11, 2026

(54) TWO-DIMENSIONAL TEMPERATURE MEASUREMENT SYSTEM AND METHOD

(71) Applicant: KOREA AEROSPACE RESEARCH INSTITUTE, Daejeon (KR)

(72) Inventors: Hyungmo KIM, Daejeon (KR); Myeonghwan CHOI, Daejeon (KR); Jaiho KIM, Daejeon (KR); Hyeontaek JO, Incheon (KR); Dong-Ho RHEE, Daejeon (KR)

(21) Appl. No.: 19/404,902

(22) Filed: Dec. 1, 2025

(30) Foreign Application Priority Data
Dec. 11, 2024 (KR) 10-2024-0183318

(51) Int. Cl. G01J 5/08; G01J 5/00; G01J 5/60

(52) U.S. Cl. CPC G01J 5/0859; G01J 5/602; G01J 2005/0077; G01J 2005/604

(57) ABSTRACT

A two-dimensional (2D) temperature measurement system includes a half mirror designed to split light incident from a measurement target into two paths by reflecting 50% of the incident light and passing the remaining 50% of the incident light, a first charge-coupled device (CCD) camera equipped with a first bandpass filter, and a second CCD camera equipped with a second bandpass filter that passes a wavelength that is different from a wavelength of the first bandpass filter, in which the half mirror splits the light incident from the measurement target into the two paths, for photographing, transmits the light in real time to the first CCD camera equipped with the first bandpass filter and the second CCD camera equipped with the second bandpass filter, and measures 2D temperature distribution in real time based on output data corresponding to the photographing.

### CROSS-REFERENCE TO RELATED APPLICATION

This application is based on and claims priority under 35 U.S.C. § 119 to Korean Patent Application No. 10-2024-0183318, filed on Dec. 11, 2024, in the Korean Intellectual Property Office, the disclosure of which is incorporated by reference herein in its entirety.

### BACKGROUND

### 1. Field

The disclosure relates to two-dimensional (2D) temperature measurement using a charge-coupled device (CCD) camera.

### 2. Description of the Related Art

According to related art, infrared cameras are widely used as a technology for measuring two-dimensional (2D) temperature distribution. Measurement technology using infrared cameras employs a method that estimates the temperature of a surface of a measurement target by measuring the intensity of infrared light emitted from the surface of the measurement object. However, in case that infrared cameras for 2D temperature measurement are used as before, as an object's emissivity that is an efficiency with which an object emits heat may vary with material and surface conditions, the value of the emissivity needs to be accurately identified for precise temperature measurement.

Moreover, according to a method of measuring a temperature in a non-contact manner using an existing pyrometer, for a two-color pyrometer that measures temperature by the ratio of output values of two photodiodes receiving different wavelengths, the two-color pyrometer is affected less by emissivity because of using the ratio of radiation emitted at two wavelengths, but temperature measurement is possible merely for a single point. Therefore, such existing methods are unsuitable for real-time inspection of the entire high-temperature surface.

### SUMMARY

The disclosure aims to improve the efficiency of temperature measurement by enabling two-dimensional (2D) temperature distribution measurement in real time. The disclosure also aims to improve the accuracy of temperature measurement by minimizing the influence of the ratio of emissivities or emissivity.

The technical problems of the disclosure are not limited to the technical problems mentioned above, and other technical problems not mentioned will be clearly understood by those of ordinary skill in the art from the description provided below.

Additional aspects will be set forth in part in the description which follows and, in part, will be apparent from the description, or may be learned by practice of the presented embodiments of the disclosure.

According to an aspect of the disclosure, a two-dimensional (2D) temperature measurement system includes a half mirror designed to split light incident from a measurement target into two paths by reflecting 50% of the incident light and passing the remaining 50% of the incident light, a first charge-coupled device (CCD) camera equipped with a first bandpass filter, and a second CCD camera equipped with a second bandpass filter that passes a wavelength that is different from a wavelength of the first bandpass filter, in which the half mirror splits the light incident from the measurement target into the two paths, for photographing, transmits the light in real time to the first CCD camera equipped with the first bandpass filter and the second CCD camera equipped with the second bandpass filter, and generates 2D temperature distribution data in real time based on output data corresponding to the photographing.

The 2D temperature measurement system according to another embodiment may collect, for each pixel, radiant light intensity data with respect to wavelengths used in the first bandpass filter and the second bandpass filter, based on the output data, and generate 2D temperature distribution data for the measurement target by calculating a temperature for each pixel using:

$$T = \frac{\{ {C}_{2} ( {λ}_{1} - {λ}_{2} ) \} / \{ {λ}_{1} {λ}_{2} \}}{ln [ ( \frac{{I}_{λ1} ( T )}{{I}_{λ2} ( T )} ) k ( \frac{{ε}_{λ2} {λ}_{1}^{5}}{{ε}_{λ1} {λ}_{2}^{5}} ) ]}$$

wherein T denotes absolute temperature, λ₁ and λ₂ respectively denote wavelengths used in the first bandpass filter 102a and the second bandpass filter 102b, ε_{λ1} and ε_{λ2} respectively denote emissivities at wavelengths of corresponding filters, I_{λ1}(T) and I_{λ2}(T) respectively denote spectral radiant light intensities of radiant energy emitted by an object having a temperature of T at the wavelengths of the corresponding filters, C₂ is a secondary radiation constant with a value of 1.4388×10⁻² m·K, and k is a temperature calibration variable.

According to another aspect of the disclosure, a two-dimensional (2D) temperature measurement method includes making light of a wavelength radiated from a surface of a measurement target be incident to a half-mirror, reflecting, at the half mirror, 50% of the incident light to transmit the light to a first charge-coupled device (CCD) camera equipped with a first bandpass filter and passing the remaining 50% of the incident light to transmit the light to a second CCD camera equipped with a second bandpass filter that passes a wavelength that is different from a wavelength of the first bandpass filter, outputting in real time data with respect to a wavelength used in the first bandpass filter based on photographing by the first CCD camera, outputting in real time data with respect to a wavelength used in the second bandpass filter based on photographing by the second CCD camera, and calculating a temperature for each pixel based on the output data to generate in real-time 2D temperature distribution data.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a conceptual diagram of a two-dimensional (2D) temperature measurement system according to an embodiment;

FIG. 2 is a graph of relative response data of a charge-coupled device (CCD) camera with respect to wavelength, which may be used in the 2D temperature measurement system of FIG. 1;

FIG. 3 is a block diagram of a 2D temperature measurement system according to an embodiment;

FIG. 4 is a flowchart of each operation of a 2D temperature measurement method using the 2D temperature measurement system according to an embodiment; and

FIG. 5 is a graph showing a Planck's blackbody radiation curve with respect to temperature to describe wavelength band limitation of a bandpass filter used in the 2D temperature measurement system according to an embodiment.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, the embodiments of the disclosure will be described in detail with reference to the accompanying drawings. However, the disclosure is not limited to the embodiments described below. Like components in the drawings will be referred to as like reference numerals, and will not be repeatedly described.

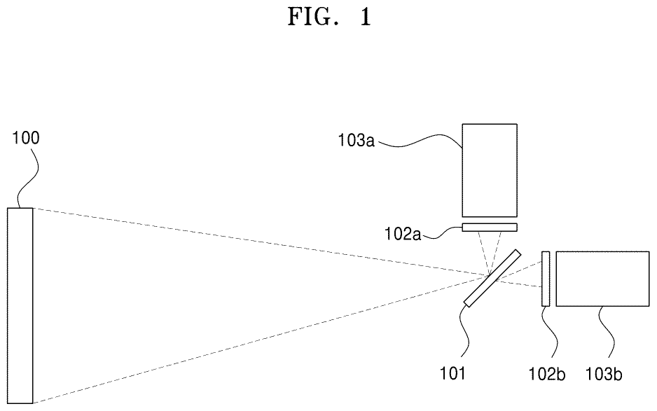

FIG. 1 is a conceptual diagram of a two-dimensional (2D) temperature measurement system according to an embodiment.

Referring to FIG. 1, the 2D temperature measurement system according to the disclosure may include a half mirror 101 that splits incident light into two paths, and two charge-coupled device (CCD) cameras 103a and 103b respectively having first and second bandpass filters 102a and 102b that transmit different wavelengths. The half mirror 101 may be configured to reflect 50% of the incident light and transmit the remaining 50%, and may split light incident from a measurement target 100 into two paths and direct them respectively to the first CCD camera 103a equipped with the first bandpass filter 102a and the second CCD camera 103b equipped with the second bandpass filter 102b for photographing. Based on data output corresponding to photographing by the first CCD camera 103a and the second CCD camera 103b, a radiation ratio of each pixel point may be calculated to measure the real-time 2D temperature distribution of the measurement target 100.

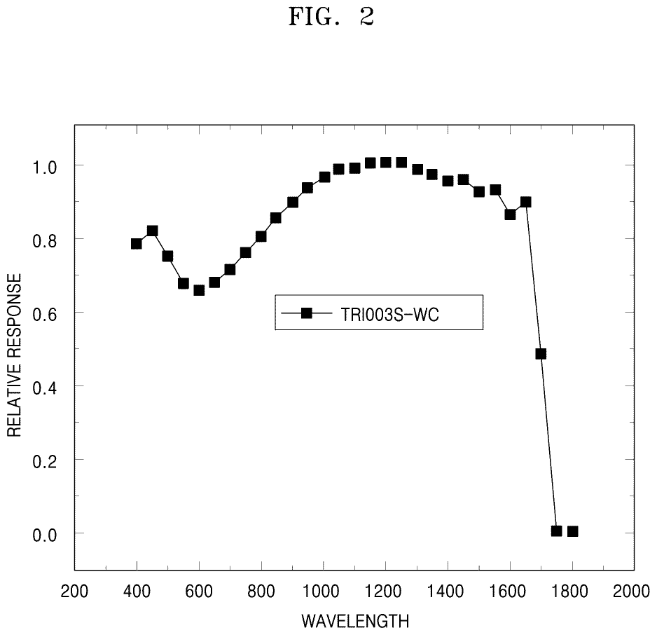

FIG. 2 is a graph of relative response data of a CCD camera with respect to wavelength, which may be used in the real-time 2D temperature measurement system of FIG. 1. The CCD camera used in the 2D temperature measurement system of FIG. 1 requires alignment thereof, and an error has to be minimized by considering such characteristics of the CCD camera. That is, by normalizing an actual radiant light intensity for each wavelength based on the relative response data with respect to wavelength differing with a camera supplier, the error of the measured temperature may be minimized. In FIG. 2, an actual radiant light intensity Iᵣₑₐₗ for each wavelength may be normalized using Equation 1.

$${I}_{real} = I / ( Relative Response ) \qquad [ Equation 1 ]$$

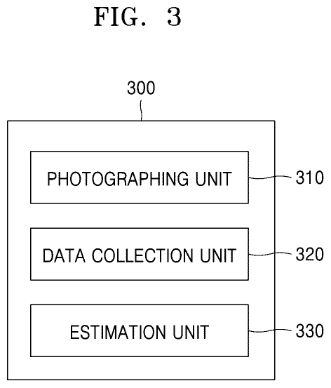

FIG. 3 is a block diagram of a 2D temperature measurement system according to an embodiment. Referring to FIG. 3, a real-time 2D temperature measurement system 300 according to an embodiment may be configured to include a photographing unit 310, a data collection unit 320, and an estimation unit 330.

The photographing unit 310 may photograph a measurement target using the first CCD camera 103a equipped with the first bandpass filter 102a and the second CCD camera 103b equipped with the second bandpass filter 102b, respectively, to generate camera output data. According to an embodiment, the first bandpass filter 102a and the second bandpass filter 102b may be set to measure wavelengths of about 1200 nm to about 1400 nm.

The data collection unit 320 may collect and store radiant light intensity data with respect to wavelength used in each bandpass filter for each pixel, based on the camera output data corresponding to the wavelength used in the corresponding bandpass filter.

The estimation unit 330 may generate 2D temperature distribution data for the measurement target by calculating a temperature for each pixel using Equation 2 based on data stored in the data collection unit 320.

$$T = \frac{\{ {C}_{2} ( {λ}_{1} - {λ}_{2} ) \} / \{ {λ}_{1} {λ}_{2} \}}{ln [ ( \frac{{I}_{λ1} ( T )}{{I}_{λ2} ( T )} ) k ( \frac{{ε}_{λ2} {λ}_{1}^{5}}{{ε}_{λ1} {λ}_{2}^{5}} ) ]} \qquad [ Equation 2 ]$$

T denotes absolute temperature, λ₁ and λ₂ respectively denote wavelengths used in the first bandpass filter 102a and the second bandpass filter 102b, ε_{λ1} and ε_{λ2} respectively denote emissivities at wavelengths of corresponding filters, I_{λ1}(T) and I_{λ2}(T) respectively denote spectral radiant light intensities of radiant energy emitted by an object having a temperature of T at the wavelengths of the corresponding filters, and C₂ is a secondary radiation constant with a value of 1.4388×10⁻² m·K. k is a temperature calibration variable that corrects a temperature difference measured across two bandpass filters by adjusting a light intensity value for a wavelength (e.g., λ₁) with a relatively greater light intensity.

For reference, emissivity represents the ratio of actually emitted energy to energy emitted by an ideal blackbody, and may have a value between 0 and 1. Equation 2 is an expression that corrects temperature calibration using a value k after dividing radiant light intensities for wavelengths by each other and then organizing a result as a value with respect to temperature, as shown in Equation 3.

$$\frac{{I}_{λ1} ( T )}{{I}_{λ2} ( T )} = \frac{{ε}_{λ1} {λ}_{2}^{5}}{{ε}_{λ2} {λ}_{1}^{5}} \frac{( {e}^{\frac{{C}_{2}}{{λ}_{2} T}} - 1 )}{( {e}^{\frac{{C}_{2}}{{λ}_{1} T}} - 1 )} \qquad [ Equation 3 ]$$

Equation 3 is obtained by substituting Wein's equation according to Equation 4, that is, an equation that describes wavelength-specific distribution of radiant energy emitted by an object, into the radiant light intensities I_{λ1}(T) and I_{λ2}(T) for each wavelength.

$$I ( λ , T ) = ε ( λ ) \cdot \frac{{C}_{1}}{{λ}^{5}} \cdot \frac{1}{{e}^{\frac{{C}_{2}}{λ T}} - 1} \qquad [ Equation 4 ]$$

I(λ, T) denotes a spectral radiant light intensity of radiant energy emitted by an object having a temperature of T at a wavelength of λ, λ represents a wavelength, T represents an absolute temperature, ε(λ) represents an emissivity at a wavelength of λ, and C₁ is a primary radiation constant calculated as C₁=2πhc² and has a value of 3.74177×10⁻¹⁶ W·m². C₂ is a secondary radiation constant, calculated as C₂=hc/k_{B}, and has a value of 1.4388×10⁻² m·K. h is Planck's constant with a value of 6.62607015×10⁻³⁴ J·s, c is the speed of light with a value of 2.99792458×10⁸ m/s, and k_{B} is Boltzmann's constant with a value of 1.380649×10⁻²³ J/K.

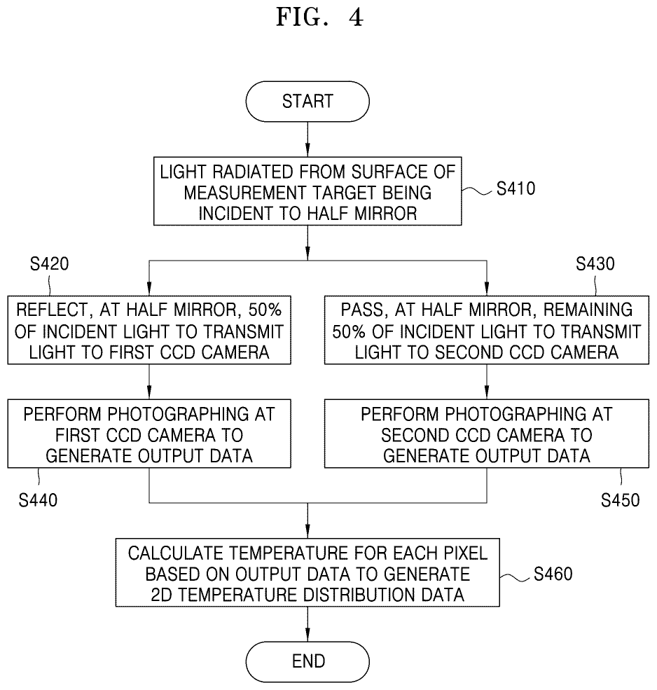

FIG. 4 is a flowchart of each operation of a 2D temperature measurement method using the 2D temperature measurement system according to an embodiment. Referring to FIG. 4, in the 2D temperature measurement method according to an embodiment, light of a wavelength radiated from a surface of a measurement target may be incident to a half-mirror, in operation S410. Subsequently, in the half mirror, 50% of the incident light may be reflected and transmitted to a first CCD camera equipped with a first bandpass filter, in operation S420, and the remaining 50% of the incident light may be passed and transmitted to a second CCD camera equipped with a second bandpass filter, in operation S430.

Next, data with respect to wavelength used in the first bandpass filter may be output based on photographing in the first CCD camera in operation S440, and data with respect to wavelength used in the second bandpass filter may be output based on photographing in the second CCD camera in operation S450. Based on the output data, a temperature may be calculated for each pixel to generate 2D temperature distribution data in operation S460.

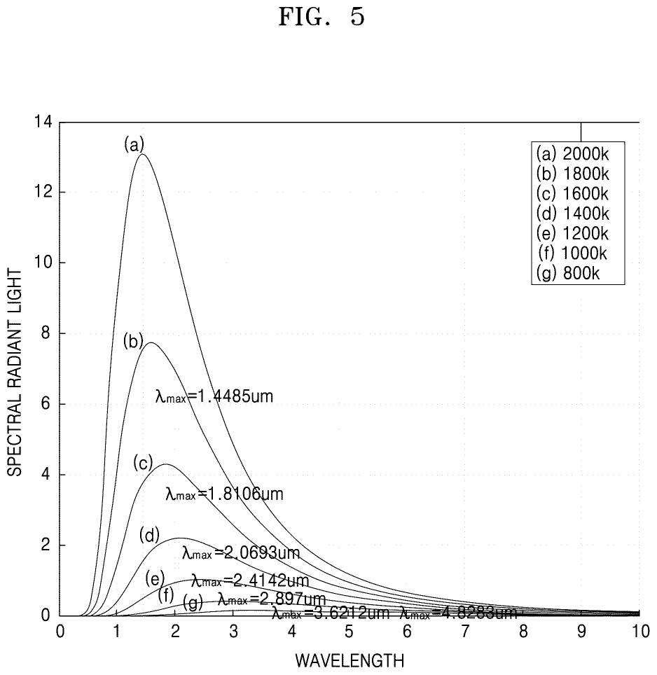

FIG. 5 is a graph showing a Planck's blackbody radiation curve with respect to temperature to describe wavelength band limitation of a bandpass filter used in the real-time 2D temperature measurement system according to an embodiment. In the graph of FIG. 5, in case that two points corresponding to the maximum slope to the left of λₘₐₓ having the best SNR are adopted as the wavelengths λ₁ and λ₂ for the first and second bandpass filters, respectively, then the difference between λ₁ and λ₂ may be reduced assuming that the ratio of emissivities, ελ₂/ελ₁, is close to 1, which is advantageous for reducing errors.

In this regard, Wein's equation of Equation 4 may be differentiated to yield zero, resulting in λₘₐₓ being determined to be 2898/T. Therefore, for example, to measure up to 2898K, the wavelength band limit may range from 0.7 μm to 1 μm. To improve SNR, a wavelength band range slightly below 1 μm, specifically 0.8 μm to 0.9 μm, may be favorable.

The above-described method may be provided as a computer program stored on a computer-readable recording medium for execution on a computer. The medium may continuously store an executable program or temporarily store the same for execution or downloading. The medium may include various recording means or storage means in a form of single hardware or a combination of several hardware, and may be distributed over a network without being limited to a medium directly connected to a certain computer system. Examples of the medium may include a magnetic medium such as a hard disk, a floppy disk, and a magnetic tape, an optical recording medium such as a compact disc (CD)-read-only memory (ROM) and a digital versatile disk (DVD), a magneto-optical medium such as a floptical disk, ROM, random-access memory (RAM), flash memory, etc., to store a program instruction. Other examples of the medium may include a recording medium or a storage medium managed by an app store that distributes applications, a site that supplies or distributes various software, a server, etc.

The method, operations, or techniques disclosed herein may be implemented by various means. For example, these techniques may be implemented in hardware, firmware, software, or a combination thereof. Those of ordinary skill in the art will understand that the various example algorithmic operations described in connection with the disclosure may be implemented using electronic hardware, computer software, or a combination thereof. To clearly explain this mutual substitution between hardware and software, various example operations have been generally described above from their functional perspective. Whether such function is implemented as hardware or software depends on the design requirements imposed on the specific application and the overall system. Those of ordinary skill in the art may implement the described features in various ways for specific applications, but such implementations should not be interpreted as falling outside the scope of the disclosure.

In hardware implementation, a processing unit used to perform the techniques may be implemented in one or more application-specific integrated circuits (ASICs), digital signal processors (DSPs), digital signal processing devices (DSPDs), programmable logic devices (PLDs), field programmable gate arrays (FPGA), a processor, a controller, a microcontroller, a microprocessor, an electronic device, another electronic unit designed to perform the functions described herein, a computer, or a combination thereof.

Therefore, the various example operations described in connection with the disclosure may be implemented or performed by any combination of a general-purpose processor, DSP, ASIC, FPGA, or other PLS, discrete gate or transistor logic, discrete hardware components, or any combination thereof designed to perform the functions described herein. A general-purpose processor may be a microprocessor, but alternatively, the processor may be any existing processor, controller, microcontroller, or state machine. The processor may also be implemented as a combination of computing devices, such as a DSP and a microprocessor, a plurality of microprocessors, one or more microprocessors coupled with a DSP core, or any other combination of components.

In firmware and/or software implementation, techniques may be implemented as instructions stored on computer-readable recording medium such as random access memory (RAM), read-only memory (ROM), non-volatile RAM (NVRAM), programmable ROM (PROM), erasable programmable ROM (EPROM), electrically erasable PROM (EEPROM), flash memory, and compact discs (CDs), magnetic or optical data storage devices, etc. The instructions may be executable by one or more processors, or may cause the processor(s) to perform specific aspects of the functions described herein.

When implemented in software, the foregoing operations may be stored on a computer-readable medium or transmitted via a computer-readable medium as one or more instructions or code. The computer-readable media may include both computer storage media and communication media, including any medium that facilitates transmission of computer programs from one location to another. The storage media may be any available media that are accessible by a computer. As non-limiting examples, such computer-readable media may include RAM, ROM, EEPROM, CD-ROM or other optical disk storage, magnetic disk storage or other magnetic storage devices, or any other medium that may be used to transfer or store desired program code in the form of instructions or data structures and are accessible by a computer. Furthermore, any connection is appropriately referred to as a computer-readable medium.

For example, in case that software is transmitted from a website, a server, or other remote sources using a coaxial cable, a fiber optic cable, a twisted wire, a digital subscriber line (DSL), or wireless technologies such as infrared, radio, and microwave, then the coaxial cable, the fiber optic cable, the twisted wire, the DSL, or wireless technologies such as infrared, radio, and microwave are included within the definition of the medium. The terms “disk” and “disc” used herein may encompass CDs, laser discs, optical discs, digital versatile discs (DVDs), floppy disks, and Blu-ray discs. The “disks” typically reproduce data magnetically, whereas the “discs” reproduce data optically using lasers. Combinations thereof need to be included within the scope of computer-readable media.

Software modules may reside in RAM memory, flash memory, ROM memory, EPROM memory, EEPROM memory, registers, hard disks, removable disks, CD-ROMs, or any other known form of storage medium. An example storage medium may be connected to a processor to enable the processor to read information from the storage medium or record information to the storage medium. Alternatively, the storage medium may be integrated into the processor. The processor and the storage medium may be within the ASIC. The ASIC may be also within a user terminal. Alternatively, the processor and the storage media may be in the user terminal as separate components.

Although the embodiments described above have been described as using aspects of the subject matter disclosed herein in one or more standalone computer systems, the disclosure is not limited thereto and may also be implemented in conjunction with any computing environment, such as a network or a distributed computing environment. Moreover, the aspects of the subject matter in the disclosure may be implemented in a plurality of processing chips or devices, and storage may similarly be affected across the plurality of devices. These devices may include PCs, network servers, and portable devices.

The embodiments of the disclosure are not limited to those described above, and various alternatives, modifications, and changes may be made within the scope apparent to those of ordinary skill in the art relating to the disclosure.

The real-time 2D temperature measurement system and method according to the disclosure may provide advantages described below.

Limitations of single-point measurement inherent in existing two-color non-contact pyrometers may be overcome, and temperature distribution of the entire surface of the measurement target may be two-dimensionally monitored in real time.

By applying a bandpass filter to a CCD camera instead of an infrared camera, it is possible to improve inaccuracies with respect to emissivity values and enhance the accuracy of temperature measurement through mathematical calculation.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A two-dimensional (2D) temperature measurement system comprising:
a half mirror designed to split light incident from a measurement target into two paths by reflecting 50% of the incident light and passing the remaining 50% of the incident light;
a first charge-coupled device (CCD) camera equipped with a first bandpass filter; and
a second CCD camera equipped with a second bandpass filter that passes a wavelength that is different from a wavelength of the first bandpass filter,
wherein the half mirror splits the light incident from the measurement target into the two paths, for photographing, transmits the light in real time to the first CCD camera equipped with the first bandpass filter and the second CCD camera equipped with the second bandpass filter, and generates 2D temperature distribution data in real time based on output data corresponding to the photographing.

2. The 2D temperature measurement system of claim 1, wherein an error of a measured temperature is minimized by normalizing an actual radiant light intensity for each wavelength based on relative response data with respect to wavelengths of the first CCD camera and the second CCD camera.

3. The 2D temperature measurement system of claim 1, wherein the first bandpass filter and the second bandpass filter are configured to measure a wavelength range of 1200 nm to 1400 nm.

4. The 2D temperature measurement system of claim 1, wherein two points corresponding to a maximum slope to the left of λₘₐₓ in a Planck's blackbody radiation curve are adopted as wavelengths of the first and second bandpass filters, respectively.

5. The 2D temperature measurement system of claim 1, wherein the 2D temperature measurement system collects, for each pixel, radiant light intensity data with respect to wavelengths used in the first bandpass filter and the second bandpass filter, based on the output data, and generates 2D temperature distribution data for the measurement target by calculating a temperature for each pixel using:
$$T = \frac{\{ {C}_{2} ( {λ}_{1} - {λ}_{2} ) \} / \{ {λ}_{1} {λ}_{2} \}}{ln [ ( \frac{{I}_{λ1} ( T )}{{I}_{λ2} ( T )} ) k ( \frac{{ε}_{λ2} {λ}_{1}^{5}}{{ε}_{λ1} {λ}_{2}^{5}} ) ]}$$
wherein T denotes absolute temperature, λ₁ and λ₂ respectively denote wavelengths used in the first bandpass filter and the second bandpass filter, ε_{λ1} and ε_{λ2} respectively denote emissivities at wavelengths of corresponding filters, I_{λ1}(T) and I_{λ2}(T) respectively denote spectral radiant light intensities of radiant energy emitted by an object having a temperature of T at the wavelengths of the corresponding filters, C₂ is a secondary radiation constant with a value of 1.4388×10⁻² m·K, and k is a temperature calibration variable.

6. A two-dimensional (2D) temperature measurement method comprising:
making light of a wavelength radiated from a surface of a measurement target be incident to a half-mirror;
reflecting, at the half mirror, 50% of the incident light to transmit the light to a first charge-coupled device (CCD) camera equipped with a first bandpass filter and passing the remaining 50% of the incident light to transmit the light to a second CCD camera equipped with a second bandpass filter that passes a wavelength that is different from a wavelength of the first bandpass filter;
outputting in real time data with respect to a wavelength used in the first bandpass filter based on photographing by the first CCD camera;
outputting in real time data with respect to a wavelength used in the second bandpass filter based on photographing by the second CCD camera; and
calculating a temperature for each pixel based on the output data to generate in real-time 2D temperature distribution data.

7. The 2D temperature measurement method of claim 6, further comprising normalizing an actual radiant light intensity for each wavelength based on relative response data with respect to wavelengths of the first CCD camera and the second CCD camera to minimize an error of a measured temperature.

8. The 2D temperature measurement method of claim 6, wherein the first bandpass filter and the second bandpass filter are configured to measure a wavelength range of 1200 nm to 1400 nm.

9. The 2D temperature measurement method of claim 6, wherein two points corresponding to a maximum slope to the left of λₘₐₓ in a Planck's blackbody radiation curve are adopted as wavelengths of the first and second bandpass filters, respectively.

10. The 2D temperature measurement method of claim 6, wherein the calculating of the temperature for each pixel based on the output data comprises collecting radiant light intensity data with respect to wavelengths used in the first bandpass filter and the second bandpass filter is collected for each pixel, based on the output data, and generating 2D temperature distribution data for the measurement target by calculating a temperature for each pixel using:
$$T = \frac{\{ {C}_{2} ( {λ}_{1} - {λ}_{2} ) \} / \{ {λ}_{1} {λ}_{2} \}}{ln [ ( \frac{{I}_{λ1} ( T )}{{I}_{λ2} ( T )} ) k ( \frac{{ε}_{λ2} {λ}_{1}^{5}}{{ε}_{λ1} {λ}_{2}^{5}} ) ]}$$
wherein T denotes absolute temperature, λ₁ and λ₂ respectively denote wavelengths used in the first bandpass filter and the second bandpass filter, ε_{λ1} and ε_{λ2} respectively denote emissivities at wavelengths of corresponding filters, I_{λ1}(T) and I_{λ2}(T) respectively denote spectral radiant light intensities of radiant energy emitted by an object having a temperature of T at the wavelengths of the corresponding filters, C₂ is a secondary radiation constant with a value of 1.4388×10⁻² m·K, and k is a temperature calibration variable.

11. A computer-readable recording medium having stored therein a computer program for executing the 2D temperature measurement method according to claim 6 on a computer system.
